(19) United States
(12) Patent Application Publication
(10) Pub. No.: US 2015/0379753 A1
(43) Pub. Date: Dec. 31, 2015

(54) MOVEMENT PROCESSING APPARATUS, MOVEMENT PROCESSING METHOD, AND COMPUTER-READABLE MEDIUM

(71) Applicant: CASIO COMPUTER CO., LTD., Tokyo (JP)

(72) Inventors: Tetsuji MAKINO, Tokyo (JP); Masaaki SASAKI, Tokyo (JP)

(73) Assignee: CASIO COMPUTER CO., LTD., Tokyo (JP)

(21) Appl. No.: 14/666,282

(22) Filed: Mar. 23, 2015

(30) Foreign Application Priority Data
Jun. 30, 2014 (JP) 2014-133637

(51) Int. Cl. G06T 13/40

(52) U.S. Cl. CPC G06T 13/40

(57) ABSTRACT

In order to allow main parts of a face to move more naturally, a movement processing apparatus includes a face main part detection unit configured to detect a main part forming a face from an acquired face image, a shape specifying unit configured to specify a shape type of the detected main part, and a movement condition setting unit configured to set a control condition for moving the main part, based on the specified shape type of the main part.

### BACKGROUND

1. Technical Field

The present invention relates to a movement processing apparatus, a movement processing method, and a computer-readable medium.

2. Related Art

In recent years, a so-called “virtual mannequin” has been proposed, in which a video is projected on a projection screen formed in a human form (see JP 2011-150221 A, for example). A virtual mannequin provides a projection image with presence as if a human stood there. This can produce novel and effective display at exhibitions and the like.

In order to enrich face expression of such a virtual mannequin, there is known a technology of expressing movements by deforming main parts (eyes, mouth, and the like, for example) forming a face in an image such as a photograph, an illustration, or a cartoon. Specific examples include a method of moving eyeballs in a face model expressed by computer graphics of a human based on the point of regard of the human which is a subject (see JP 06-282627 A, for example), and a method of realizing lip-sync by changing the shape of a mouth by each consonant or vowel of a pronounced word (see JP 2003-58908 A, for example).

Meanwhile, regarding main parts of a face to be processed, the forms thereof vary according to the types of source images such as photographs and illustrations and the types of the faces such as humans and animals. As such, if data for moving the main parts of a human face in a photographic image is used for deformation of a cartoon face or deformation of an animal face in an illustration, there is a problem that degradation of local image quality or unnatural deformation is caused, whereby viewers feel a sense of incongruity.

### SUMMARY

The present invention has been developed in view of such a problem. An object of the present invention is to allow the main parts of a face to move more naturally.

A movement processing apparatus comprising:

an acquisition unit configured to acquire a face image;

a detection unit configured to detect a main part forming a face;

a control unit configured to:

specify a shape type of the main part; and

set a control condition for moving the main part based on the specified shape type of the main part.

According to the present invention, it is possible to allow the main parts of a face to move more naturally.

### BRIEF DESCRIPTION OF THE DRAWINGS

FIG. 1 is a block diagram illustrating a schematic configuration of a movement processing apparatus according to an embodiment to which the present invention is applied;

FIG. 2 is a flowchart illustrating an exemplary movement according to face movement processing by the movement processing apparatus of FIG. 1;

FIG. 3 is a flowchart illustrating an exemplary movement according to eye control condition setting processing in the face movement processing of FIG. 2;

FIG. 4A is an illustration for explaining the eye control condition setting processing of FIG. 3;

FIG. 4B is an illustration for explaining the eye control condition setting processing of FIG. 3;

FIG. 4C is an illustration for explaining the eye control condition setting processing of FIG. 3;

FIG. 5A is an illustration for explaining the eye control condition setting processing of FIG. 3;

FIG. 5B is an illustration for explaining the eye control condition setting processing of FIG. 3;

FIG. 5C is an illustration for explaining the eye control condition setting processing of FIG. 3;

FIG. 6A is an illustration for explaining the eye control condition setting processing of FIG. 3;

FIG. 6B is an illustration for explaining the eye control condition setting processing of FIG. 3;

FIG. 6C is an illustration for explaining the eye control condition setting processing of FIG. 3;

FIG. 7 is a flowchart illustrating an exemplary operation according to mouth control condition setting processing in the face movement processing of FIG. 2;

FIG. 8A is an illustration for explaining the mouth control condition setting processing of FIG. 7;

FIG. 8B is an illustration for explaining the mouth control condition setting processing of FIG. 7;

FIG. 8C is an illustration for explaining the mouth control condition setting processing of FIG. 7;

FIG. 9A is an illustration for explaining the mouth control condition setting processing of FIG. 7;

FIG. 9B is an illustration for explaining the mouth control condition setting processing of FIG. 7;

FIG. 9C is an illustration for explaining the mouth control condition setting processing of FIG. 7;

FIG. 10A is an illustration for explaining the mouth control condition setting processing of FIG. 7;

FIG. 10B is an illustration for explaining the mouth control condition setting processing of FIG. 7;

FIG. 10C is an illustration for explaining the mouth control condition setting processing of FIG. 7;

FIG. 11A is an illustration for explaining the mouth control condition setting processing of FIG. 7;

FIG. 11B is an illustration for explaining the mouth control condition setting processing of FIG. 7; and

FIG. 11C is an illustration for explaining the mouth control condition setting processing of FIG. 7.

### DETAILED DESCRIPTION

Hereinafter, specific modes of the present invention will be described using the drawings. However, the scope of the invention is not limited to the examples shown in the drawings.

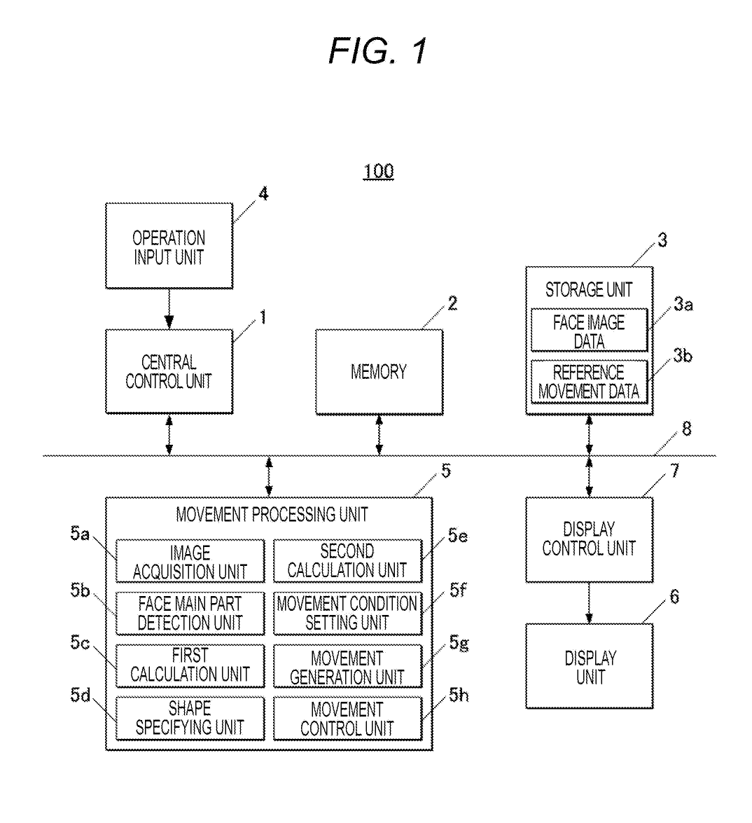

FIG. 1 is a block diagram illustrating a schematic configuration of a movement processing apparatus 100 of a first embodiment to which the present invention is applied.

The movement processing apparatus 100 is configured of a computer or the like such as a personal computer or a work station, for example. As illustrated in FIG. 1, the movement processing apparatus 100 includes a central control unit 1, a memory 2, a storage unit 3, an operation input unit 4, a movement processing unit 5, a display unit 6, and a display control unit 7.

The central control unit 1, the memory 2, the storage unit 3, the movement processing unit 5, and the display control unit 7 are connected with one another via a bus line 8.

The central control unit 1 controls respective units of the movement processing apparatus 100.

Specifically, the central control unit 1 includes a central processing unit (CPU; not illustrated) which controls the respective units of the movement processing apparatus 100, a random access memory (RAM), and a read only memory (ROM), and performs various types of control operations according to various processing programs (not illustrated) of the movement processing apparatus 100.

The memory 2 is configured of a dynamic random access memory (DRAM) or the like, for example, and temporarily stores data and the like processed by the respective units of the movement processing apparatus 100, besides the central control unit 1.

The storage unit 3 is configured of a non-volatile memory (flash memory), a hard disk drive, and the like, for example, and stores various types of programs and data (not illustrated) necessary for operation of the central control unit 1.

The storage unit 3 also stores face image data 3a.

The face image data 3a is data of a two-dimensional face image including a face. Specifically, the face image data 3a is image data of a face image of a human in a photographic image, a face image of a human or an animal expressed as a cartoon, or an face image of a human or an animal in an illustration, for example. The face image data 3a may be image data of an image including at least a face. For example, the face image data 3a may be image data of a face only, or image data of the part above the chest.

It should be noted that a face image according to the face image data 3a is an example, and is not limited thereto. It can be changed in any way as appropriate.

The storage unit 3 also stores reference movement data 3b.

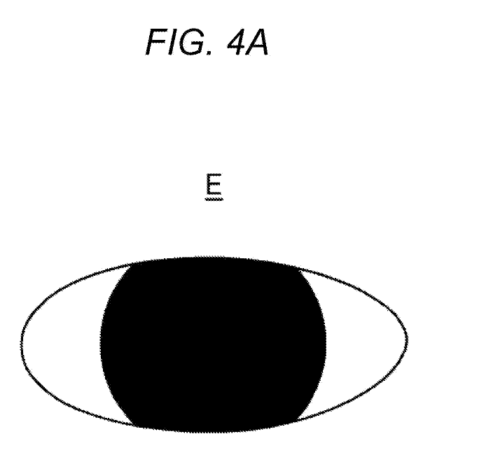

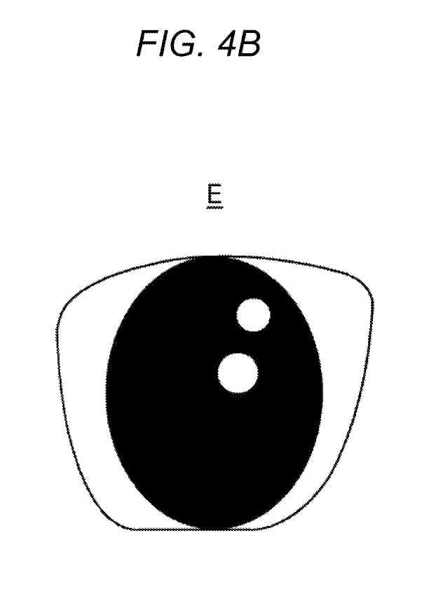

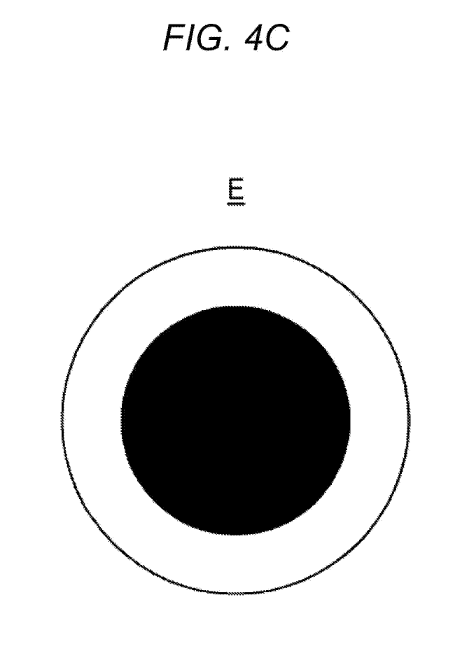

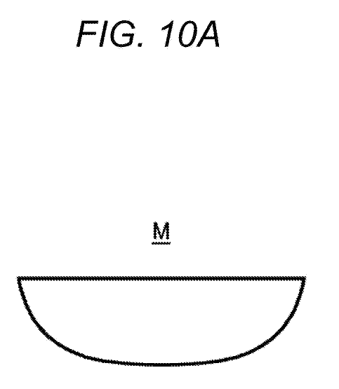

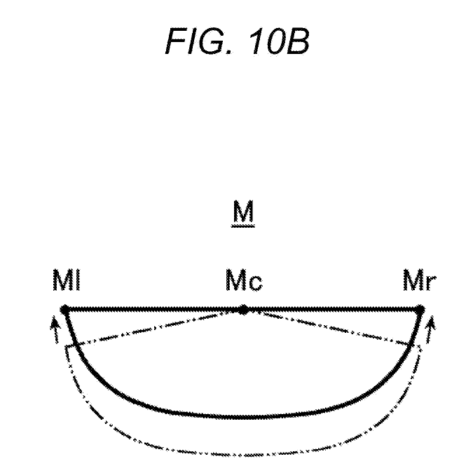

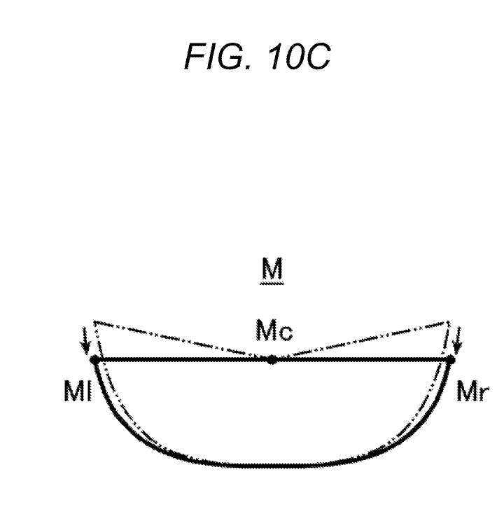

The reference movement data 3b includes information showing movements serving as references when expressing movements of respective main parts (for example, an eye E (see FIG. 4A and elsewhere), a mouth M (see FIG. 10A and elsewhere), and the like) of a face. Specifically, the reference movement data 3b is defined for each of the main parts, and includes information showing movements of a plurality of control points in a given space. For example, information representing position coordinates (x, y) of a plurality of control points in a given space and deformation vectors and the like are aligned along the time axis.

As such, in the reference movement data 3b of the eye E, for example, a plurality of control points corresponding to the upper eyelid and the lower eyelid are set, and deformation vectors of these control points are defined. Further, in the reference movement data 3b of the mouth M, a plurality of control points corresponding to the upper lip, the lower lip, and the right and left corners of the mouth are set, and deformation vectors of these control points are defined.

The operation input unit 4 includes operation units (not illustrated) such as a keyboard, a mouse, and the like, configured of data input keys for inputting numerical values, characters, and the like, an up/down/left/right shift key for performing data selection, data feeding operation, and the like, various function keys, and the like. According to an operation of the operation units, the operation input unit 4 outputs a predetermined operation signal to the central control unit 1.

The movement processing unit 5 includes an image acquisition unit 5a, a face main part detection unit 5b, a first calculation unit 5c, a shape specifying unit 5d, a second calculation unit 5e, a movement condition setting unit 5f, a movement generation unit 5g, and a movement control unit 5h.

It should be noted that while each unit of the movement processing unit 5 is configured of a predetermined logic circuit, for example, such a configuration is an example, and the configuration of each unit is not limited thereto.

The image acquisition unit 5a acquires the face image data 3a.

That is to say, that the image acquisition unit 5a acquires the face image data 3a of a two-dimensional image including a face which is a processing target of face movement processing. Specifically, the image acquisition unit 5a acquires the face image data 3a desired by a user, which is designated by a predetermined operation of the operation input unit 4 by the user, among a given number of units of the face image data 3a stored in the storage unit 3, as a processing target of face movement processing, for example.

It should be noted that the image acquisition unit 5a may acquire face image data from an external device (not illustrated) connected via a communication control unit not illustrated, or acquire face image data generated by being captured by an imaging unit not illustrated.

The face main part detection unit 5b detects main parts forming a face from a face image.

That is to say, the face main part detection unit 5b detects main parts such as right and left eyes and eyebrows, nose, mouth, and face contour, from a face image of face image data acquired by the image acquisition unit 5a, through processing using active appearance model (AAM), for example.

Here, AAM is a method of modeling a visual event, which is processing of modeling an image of an arbitrary face area. For example, the face main part detection unit 5b registers, in a given registration unit, statistical analysis results of positions and pixel values (for example, luminance values) of predetermined feature parts (for example, corner of an eye, tip of nose, face line, and the like) in a plurality of sample face images. Then, with use of the positions of the feature parts as the basis, the face main part detection unit 5b sets a shape model representing a face shape and a texture model representing an “appearance” in an average shape, and performs modeling of a face image using such models. Thereby, the main parts such as eyes, eyebrows, nose, mouth, face contour, and the like are modeled in the face image.

It should be noted that while AAM is used in detecting the main parts, it is an example, and the present invention is not limited to this. For example, it can be changed to any method such as edge extraction processing, anisotropic diffusion processing, or template matching, as appropriate.

The first calculation unit 5c calculates a length in a given direction of the eye E as a main part of a face.

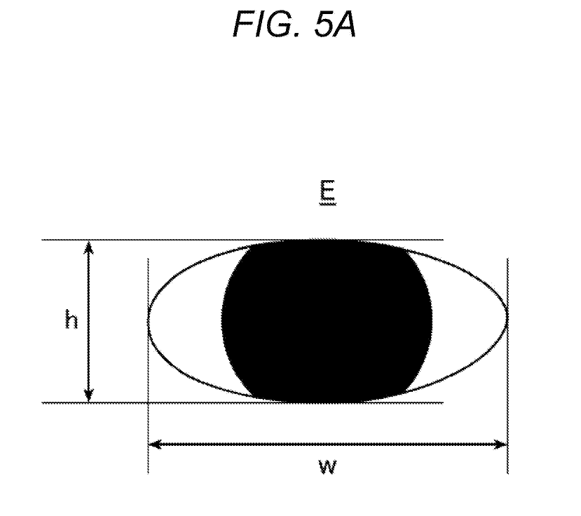

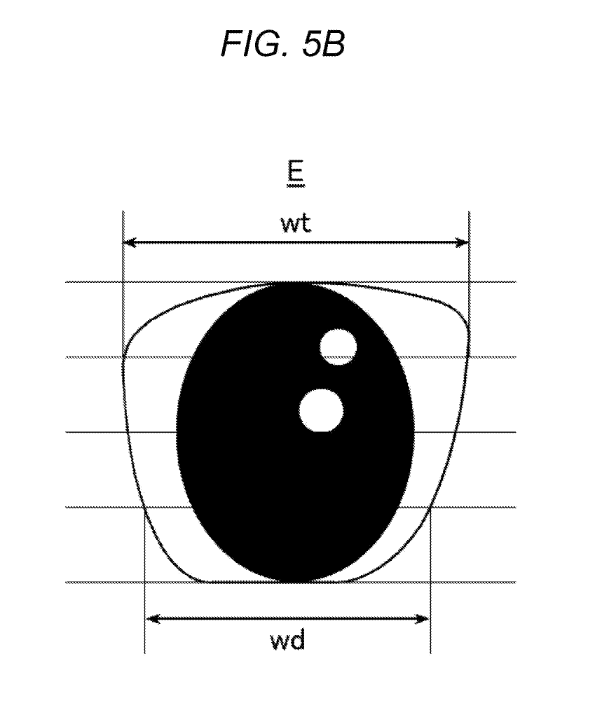

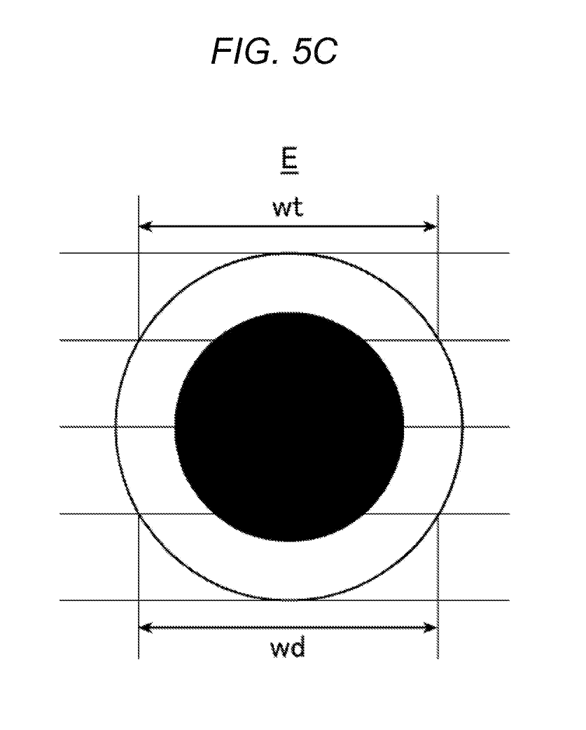

That is to say, the first calculation unit 5c calculates a length in an up and down direction (vertical direction y) and a length in a right and left direction (horizontal direction x) of the eye E, respectively. Specifically, in the eye E detected by the face main part detection unit 5b, the first calculation unit 5c calculates the number of pixels in a portion where the number of pixels in an up and down direction is the maximum as a length h in the up and down direction, and the number of pixels in a portion where the number of pixels in a right and left direction is the maximum as a length w in the right and left direction, respectively (see FIG. 5A).

The first calculation unit 5c also calculates a length in a right and left direction of an upper side portion and a lower side portion of the eye E. Specifically, the first calculation unit 5c divides the eye E, detected by the face main part detection unit 5b, into a plurality of areas (for example, four areas) of an almost equal width in an up and down direction, and detects the number of pixels in a right and left direction of the parting line between the top area and an immediately lower area thereof as a length wt of the upper portion of the eye E, and the number of pixels in a right and left direction of the parting line between the bottom area and an immediately upper area thereof as a length wb of the lower portion of the eye E, respectively (see FIGS. 5B and 5C).

The shape specifying unit 5d specifies the shape types of the main parts.

That is to say, the shape specifying unit (specifying unit) 5d specifies the shape types of the main parts detected by the face main part detection unit 5b. Specifically, the shape specifying unit 5d specifies the shape types of the eye E and the mouth M as the main parts, for example.

For example, when specifying the shape type of the eye E, the shape specifying unit 5d calculates a ratio (h/w) between the lengths in the up and down direction and in the right and left direction of the eye E calculated by the first calculation unit 5c, and according to whether or not the ratio (h/w) is within a predetermined range, determines whether or not it is a shape of a humane eye E (for example, oblong elliptical shape; see FIG. 4A). Further, the shape specifying unit 5d compares the lengths wt and wb in the right and left direction of the upper portion and the lower portion of the eye E calculated by the first calculation unit 5c, and according to whether or not the lengths wt and wb are almost equal, determines whether it is a shape of a cartoon-like eye E (see FIG. 4B) or a shape of an animal-like eye E (for example, almost true circular shape; see FIG. 4C).

Further, when specifying the shape type of the mouth M, the shape specifying unit 5d specifies the shape type of the mouth M based on the positional relation in an up and down direction between the right and left mouth corners Mr and Ml and the mouth center portion Mc.

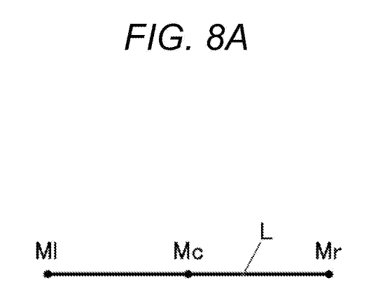

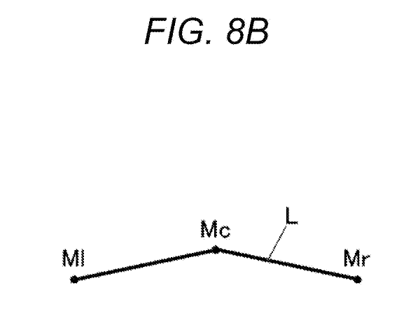

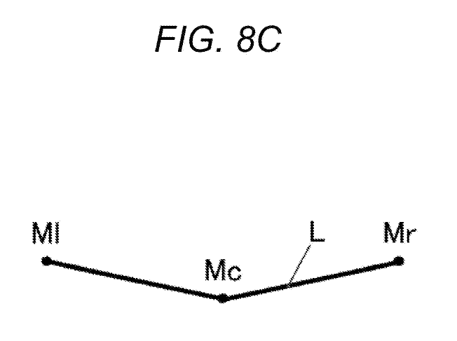

Specifically, the shape specifying unit 5d specifies the both right and left end portions of a boundary line L, which is a joint between the upper lip and the lower lip of the mouth M detected by the face main part detection unit 5b, as positions of the right and left mouth corners Mr and Ml, and specifies an almost center portion in the right and left direction of the boundary line L as the mouth center portion Mc. Then, based on the positional relation in the up and down direction between the right and left mouth corners Mr and Ml and the mouth center portion Mc, the shape specifying unit 5d determines whether it is a shape of the mouth M in which the right and left mouth corners Mr and Ml and the mouth center portion Mc are almost equal in the up and down positions (see FIG. 8A), or it is a shape of the mouth M in which the mouth center portion Mc is high relative to the right and left mouth corners Mr and Ml in the up and down positions (see FIG. 8B), or it is a shape of the mouth M in which the right and left mouth corners Mr and Ml are high relative to the mouth center portion Mc in the up and down positions (see FIG. 8C).

It should be noted that the shape types of the eye E and the mouth M are examples, and they are not limited thereto. The shape types can be changed in any way as appropriate. Further, while the eye E and the mouth M are exemplarily illustrated as main parts and the shape types thereof are specified, this is an example, and the present invention is not limited thereto. For example, other main parts such as nose, eyebrows, and face contour may be used.

The second calculation unit 5e calculates a length in a predetermined direction related to the mouth M as a main part.

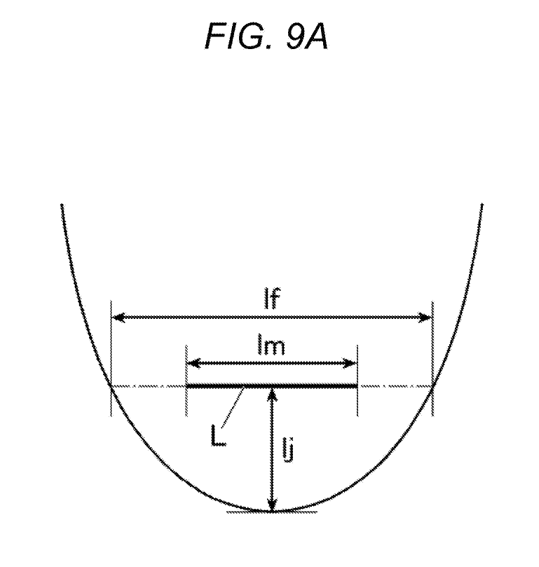

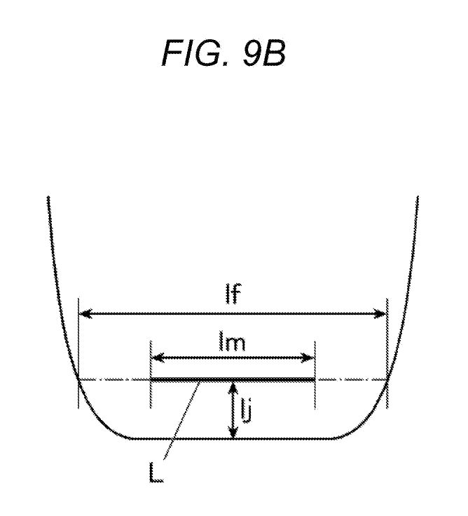

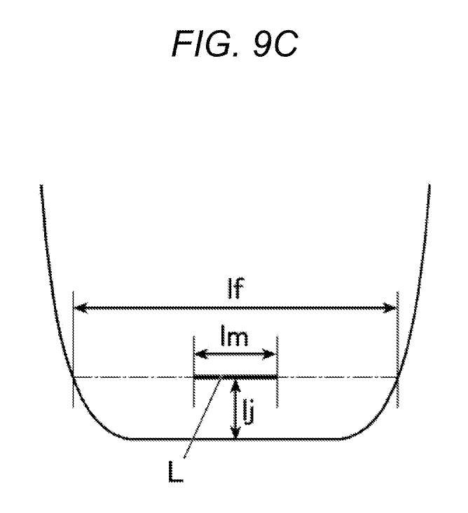

That is to say, the second calculation unit 5e calculates a length lm in a right and left direction of the mouth M, a length lf in a right and left direction of the face at a position corresponding to the mouth M, and a length lj in an up and down direction from the mouth M to the tip of the chin, respectively (see FIG. 9A and elsewhere).

Specifically, the second calculation unit 5e calculates the number of pixels in a right and left direction between the both right and left ends (right and left mouth corners Mr and Ml) of the boundary line L of the mouth M, as a length lm in the right and left direction of the mouth M. Further, the second calculation unit 5e specifies two intersections between a line extending in a right and left direction through the both right and left ends of the boundary line L of the mouth M and the face contour detected by the face main part detection unit 5b, and calculates the number of pixels in a right and left direction between the two intersections as the length lf in the right and left direction of the face at the position corresponding to the mouth M. Further, the second calculation unit 5e specifies an intersection between a line extending in an up and down direction passing through an almost center portion in the right and left direction of the boundary line L of the mouth M (mouth center portion Mc) and the face contour detected by the face main part detection unit 5b, and calculates the number of pixels in an up and down direction between the specified intersection and the mouth center portion Mc as a length lj in an up and down direction from the mouth M to the tip of the chin

The movement condition setting unit 5f sets control conditions for moving the main parts.

That is to say, the movement condition setting unit 5f sets control conditions for moving the main parts based on the shape types of the main parts (for example, the eye E, the mouth M, and the like) specified by the shape specifying unit 5d. Specifically, the movement condition setting unit 5f sets control conditions for allowing blink movement of the eye E, based on the shape type of the eye E specified by the shape specifying unit 5d. Further, the movement condition setting unit 5f sets control conditions for allowing opening/closing movement of the mouth M based on the shape type of the mouth M specified by the shape specifying unit 5d.

For example, the movement condition setting unit 5f reads and acquires the reference movement data 3b of a main part to be processed from the storage unit 3, and based on the type of shape of the main part specified by the shape specifying unit 5d, sets, as control conditions, correction contents of information showing the movements of a plurality of control points for moving the main part included in the reference movement data 3b.

Specifically, when setting control conditions for allowing blink movement of the eye E, the movement condition setting unit 5f sets, as control conditions, correction contents of information showing the movements of a plurality of control points corresponding to the upper eyelid and the lower eyelid included in the reference movement data 3b, based on the shape type of the eye E specified by the shape specifying unit 5d.

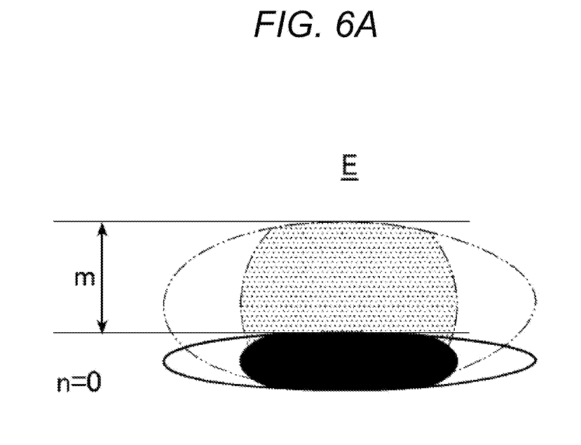

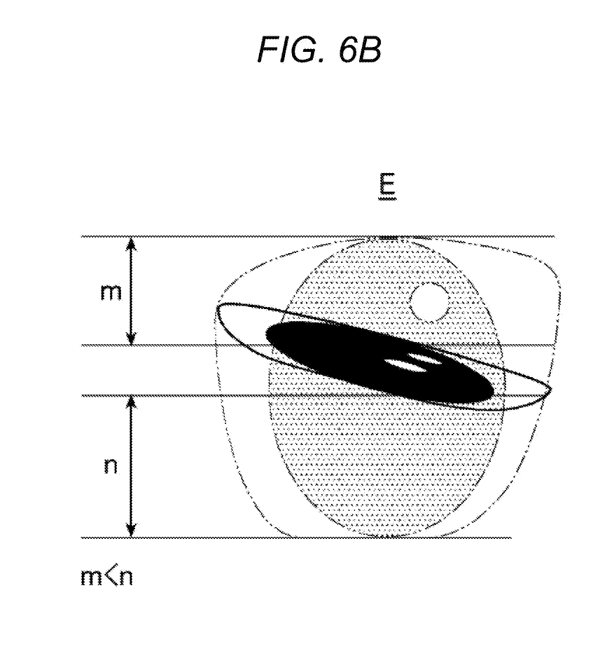

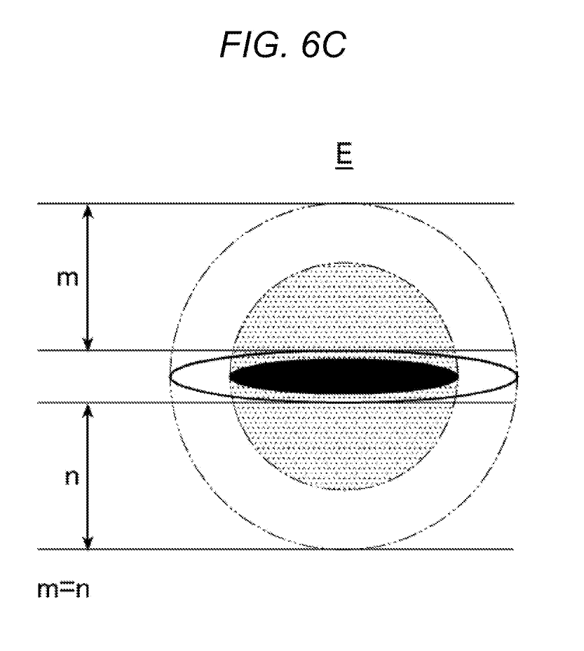

Further, the movement condition setting unit 5f may set control conditions for controlling deformation of at least one of the upper eyelid and the lower eyelid for allowing blink movement of the eye E, according to the lengths wt and wb in the right and left direction of the upper portion and the lower portion of the eye E calculated by the first calculation unit 5c. For example, the movement condition setting unit 5f compares the lengths wt and wb in the right and left direction of the upper portion and the lower portion of the eye E, and sets correction contents of the information showing the movements of the control points corresponding to the upper eyelid and the lower eyelid included in the reference movement data 3b such that the deformation amount of the eyelid corresponding to the shorter length (for example, a deformation amount n of the lower eyelid) becomes relatively larger than the deformation amount of the eyelid corresponding to the longer length (for example, a deformation amount m of the upper eyelid) (see FIG. 6B). Further, if the lengths wt and wb in the right and left direction of the upper portion and the lower portion of the eye E are almost equal (see FIG. 6C), the movement condition setting unit 5f sets correction contents of the information showing the movements of the control points corresponding to the upper eyelid and the lower eyelid included in the reference movement data 3b such that the deformation amount m of the upper eyelid and the deformation amount n of the lower eyelid become almost equal.

Further, when setting control conditions for allowing opening/closing movement of the mouth M, the movement condition setting unit 5f sets, as control conditions, correction contents of information showing the movements of a plurality of control points corresponding to the upper lip, the lower lip, and the right and left mouth corners Mr and Ml included in the reference movement data 3b, based on the shape type of the mouth M specified by the shape specifying unit 5d.

For example, if the shape of the mouth M specified by the shape specifying unit 5d is a shape in which the mouth center portion Mc is high relative to the right and left mouth corners Mr and Ml in the up and down positions (see FIG. 10B), the movement condition setting unit 5f sets correction contents of the information showing the movements of the control points corresponding to the mouth corners Mr and Ml included in the reference movement data 3b such that a deformation amount in an upward direction of the right and left mouth corners Mr and Ml becomes relatively large. Further, if the shape of the mouth M specified by the shape specifying unit 5d is a shape in which the right and left mouth corners Mr and Ml are high relative to the mouth center portion Mc in the up and down positions (see FIG. 10C), the movement condition setting unit 5f sets correction contents of the information showing the movements of the control points corresponding to the right and left mouth corners Mr and Ml included in the reference movement data 3b such that a deformation amount in a downward direction of the right and left mouth corners Mr and Ml becomes relatively larger.

Further, the movement condition setting unit 5f may set control conditions for allowing opening/closing movement of the mouth M based on the relative positional relation of the mouth M to a main part (for example, tip of the chin) other than the mouth M detected by the face main part detection unit 5b.

Specifically, the movement condition setting unit 5f specifies a relative positional relation of the mouth M to a main part other than the mouth M based on the length lm in the right and left direction of the mouth M, the length if in the right and left direction of the face at a position corresponding to the mouth M, and the length lj in the up and down direction from the mouth M to the tip of the chin, calculated by the second calculation unit 5e. Then, based on the specified positional relation, the movement condition setting unit 5f sets control conditions for controlling deformation of at least one of the upper lip and the lower lip for allowing opening/closing movement of the mouth M. For example, the movement condition setting unit 5f compares the length lm in the right and left direction of the mouth M with the length if in the right and left direction of the face at the position corresponding to the mouth M, to thereby specify the sizes of the right and left areas of the mouth M in the face contour. Then, based on the sizes of the right and left areas of the mouth M in the face contour and the length lj in the up and down direction from the mouth M to the tip of the chin, the movement condition setting unit 5f sets control conditions for controlling opening/closing in an up and down direction and opening/closing in a right and left direction when allowing opening/closing movement of the mouth M.

That is to say, deformation amounts in a right and left direction and an up and down direction in opening/closing movement of the mouth M are changed on the basis of the size of the mouth M, in particular, the length lm in the right and left direction of the mouth M. For example, in general, as the length lm is larger, deformation amounts in the right and left direction and the up and down direction at the time of opening/closing movement of the mouth M are larger. As such, in the case where the sizes on the right and left areas of the mouth M in the face contour and the length lj in the up and down direction from the mouth M to the tip of the chin are relatively large with reference to the length lm in the right and left direction of the mouth M, it is considered that there is no problem in deforming the mouth M based on the reference movement data 3b.

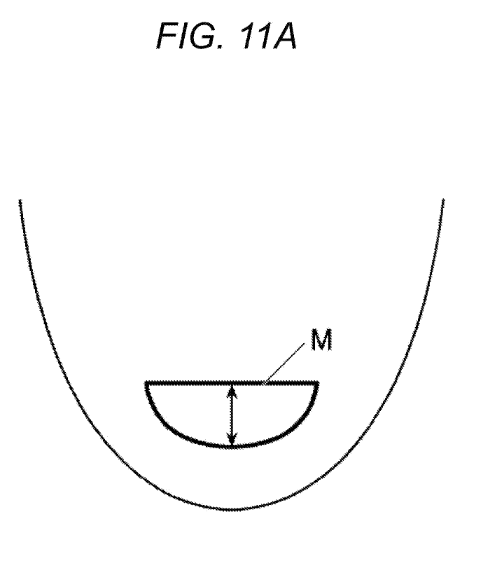

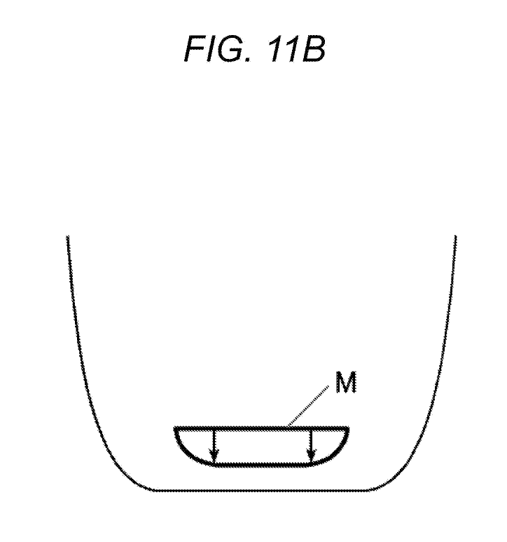

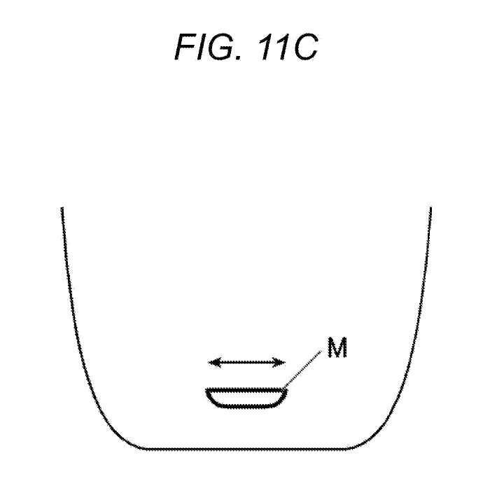

On the other hand, if the length lj in the up and down direction from the mouth M to the tip of the chin is relatively small (see FIG. 11B), the movement condition setting unit 5f sets correction contents of the information showing the movements of the control points corresponding to the upper lip and the lower lip included in the reference movement data 3b such that a deformation amount in a downward direction of the lower lip becomes relatively smaller. Further, if the sizes of the right and left areas on the mouth M in the face contour is relatively large (see FIG. 11C), the movement condition setting unit 5f sets correction contents of the information showing the movements of the control points corresponding to the right and left mouth corners Mr and Ml included in the reference movement data 3b such that a deformation amount in the right and left direction of the right and left mouth corners Mr and Ml becomes relatively larger.

It should be noted that the control conditions set by the movement condition setting unit 5f may be output to a given storage unit (for example, the memory 2 or the like) and stored temporarily.

Further, the control contents for moving the main parts such as the eye E and the mouth M as described above are examples, and the present invention is not limited thereto. The control contents may be changed in any way as appropriate.

Further, while the eye E and the mouth M are exemplarily shown as main parts and control conditions thereof are set, they are examples, and the present invention is not limited thereto. For example, another main part such as nose, eyebrows, face contour, or the like may be used, for example. In that case, it is possible to set control conditions of another main part, while taking into account the control conditions for moving the eye E and the mouth M. That is to say, it is possible to set control conditions for moving a main part such as an eyebrow or a nose, which is near the eye E, in a related manner, while taking into account the control conditions for allowing blink movement of the eye E. Further, it is also possible to set control conditions for moving a main part such as a nose or a face contour, which is near the mouth M, in a related manner, while taking into account the control conditions for allowing opening/closing movement of the mouth.

The movement generation unit 5g generates movement data for moving main parts, based on the control conditions set by the movement condition setting unit 5f.

Specifically, based on the reference movement data 3b of a main part to be processed and the correction contents of the reference movement data 3b set by the movement condition setting unit 5f, the movement generation unit 5g corrects information showing the movements of a plurality of control points and generates the corrected data as movement data of the main part.

It should be noted that the movement data generated by the movement generation unit 5g may be output to a given storage unit (for example, memory 2 or the like) and stored temporarily.

The movement control unit 5h moves a main part in a face image.

That is to say, the movement control unit 5h moves a main part according to control conditions set by the movement condition setting unit 5f in the face image acquired by the image acquisition unit 5a. Specifically, the movement control unit 5h sets a plurality of control points at given positions of the main part to be processed, and acquires movement data of the main part to be processed generated by the movement generation unit 5g. Then, the movement control unit 5h performs deformation processing to move the main part by displacing the control points based on the information showing the movements of the control points defined in the acquired movement data.

The display unit 6 is configured of a display such as a liquid crystal display (LCD), a cathode ray tube (CRT), or the like, and displays various types of information on the display screen under control of the display control unit 7.

The display control unit 7 performs control of generating display data and allowing it to be displayed on the display screen of the display unit 6.

Specifically, the display control unit 7 includes a video card (not illustrated) including a graphics processing unit (GPU), a video random access memory (VRAM), and the like, for example. Then, according to a display instruction from the central control unit 1, the display control unit 7 generates display data of various types of screens for moving the main parts by face movement processing, through drawing processing by the video card, and outputs it to the display unit 6. Thereby, the display unit 6 displays a content which is deformed in such a manner that the main parts (eye E, mouth M, and the like) of the face image are moved or the face expression is changed by the face movement processing, for example.

### <Face Movement Processing>

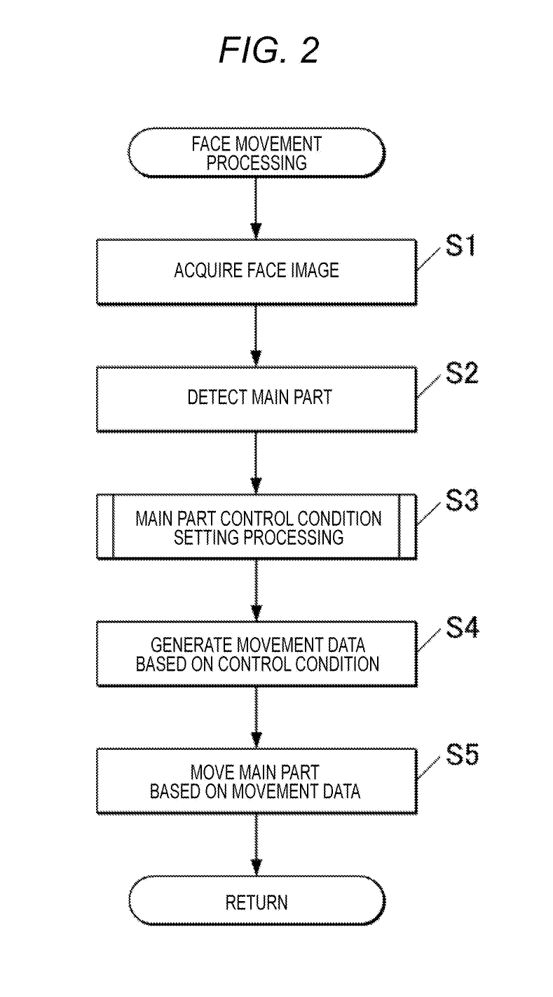

Next, face movement processing will be described with reference to FIGS. 2 to 11.

FIG. 2 is a flowchart illustrating an exemplary operation according to the face movement processing.

As illustrated in FIG. 2, the image acquisition unit 5a of the movement processing unit 5 first acquires the face image data 3a desired by a user designated based on a predetermined operation of the operation input unit 4 by the user, among a given number of units of the face image data 3a stored in the storage unit 3, for example (step S1).

Next, the face main part detection unit 5b detects main parts such as right and left eyes, nose, mouth, eyebrows, face contour, and the like, through the processing using the AAM, for example, from the face image of the face image data acquired by the image acquisition unit 5a (step S2).

Then, the movement processing unit 5 performs main part control condition setting processing to set control conditions for moving the main parts detected by the face main part detection unit 5b (step S3).

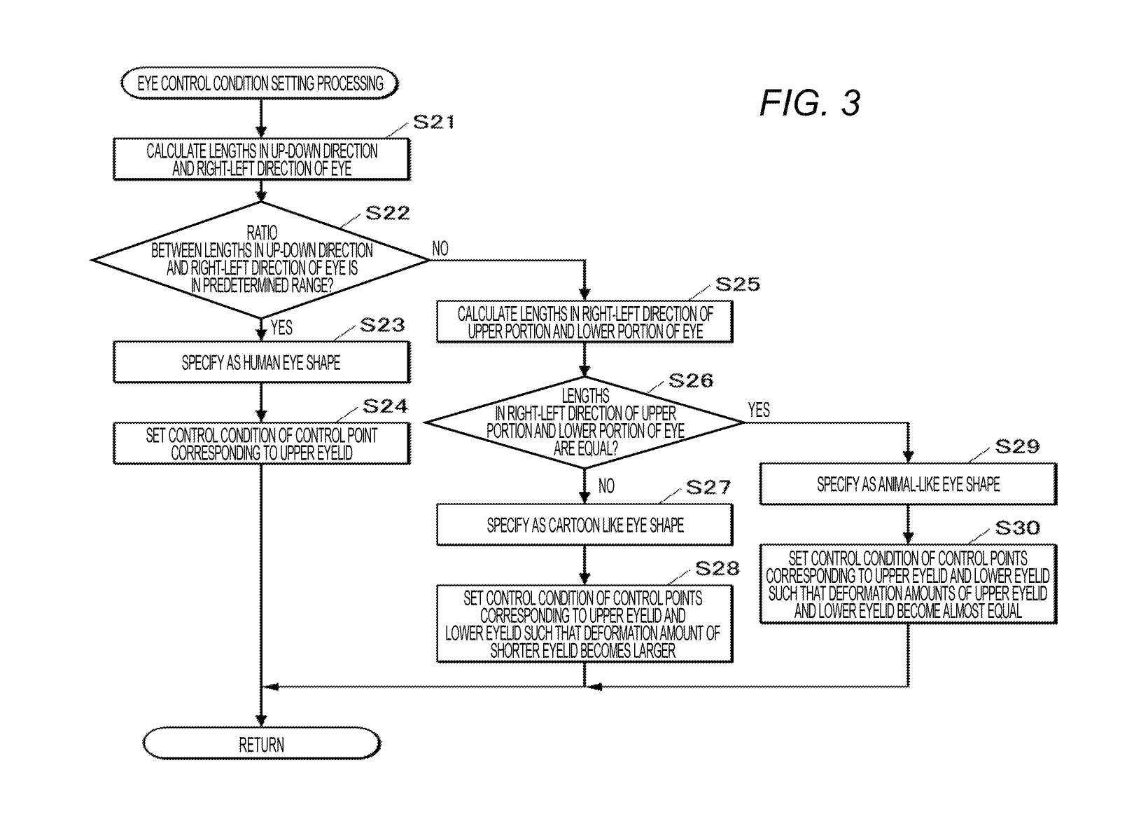

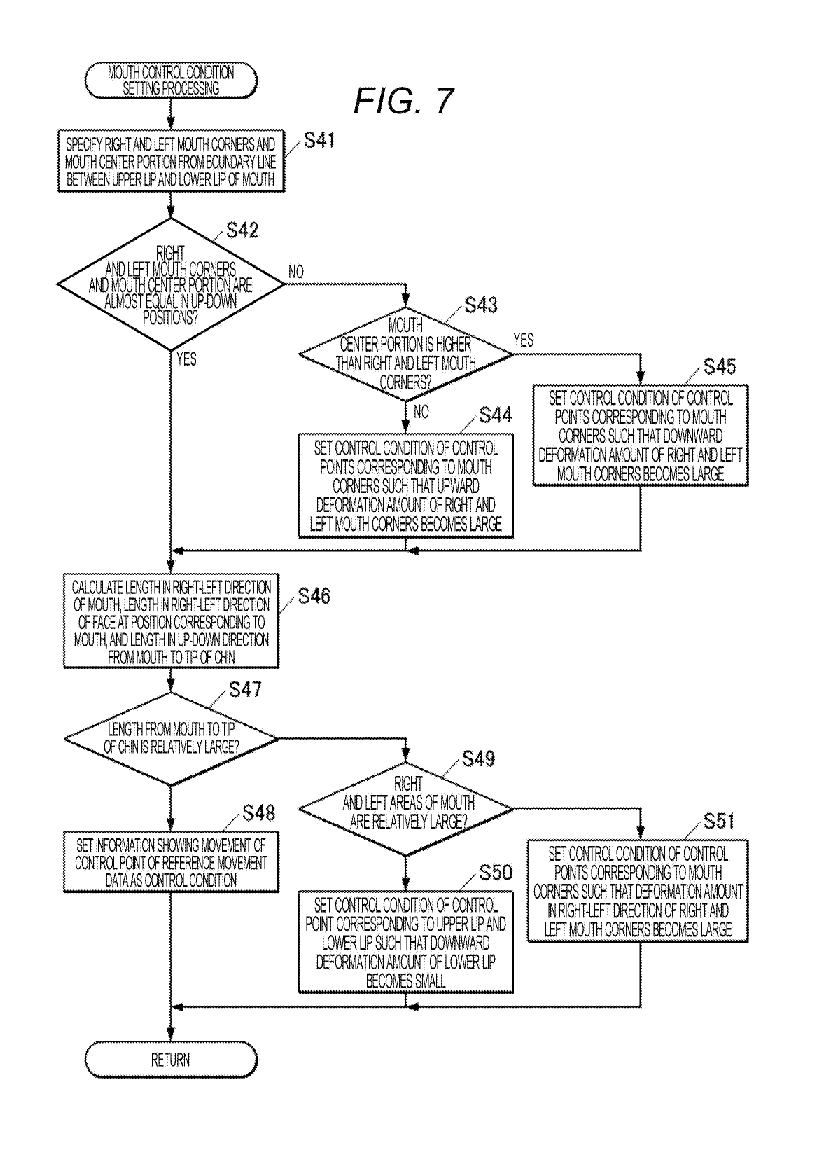

It should be noted that while the details of the processing content will be described below, as the main part control condition setting processing, eye control condition setting processing (see FIG. 3) and mouth control condition setting processing (see FIG. 7) will be exemplarily described.

Next, the movement generation unit 5g generates movement data for moving the main parts, based on the control conditions set by the main part control condition setting processing (step S4). Then, based on the movement data generated by the movement generation unit 5g, the movement control unit 5h performs processing to move the main parts in the face image (step S5).

For example, the movement generation unit 5g generates movement data for moving the eye E and the mouth M based on the control conditions set by the eye control condition setting processing and the mouth control condition setting processing. Based on the movement data generated by the movement generation unit 5g, the movement control unit 5h performs processing to move the eye E and the mouth M in the face image.

### <Eye Control Condition Setting Processing>

Next, the eye control condition setting processing will be described with reference to FIGS. 3 to 6.

FIG. 3 is a flowchart illustrating an exemplary operation according to the eye control condition setting processing. Further, FIGS. 4A to 4C, FIGS. 5A to 5C, and FIGS. 6A to 6C are diagrams for explaining the eye control condition setting processing.

It should be noted that the eye E in each of FIGS. 4A to 4C, FIGS. 5A to 5C, and FIGS. 6A to 6C schematically represents the left eye (seen on the right side in the image).

As illustrated in FIG. 3, the first calculation unit 5c calculates the length h in the up and down direction and the length w in the right and left direction of the eye E detected as a main part by the face main part detection unit 5b, respectively (step S21; see FIG. 5A).

Then, the shape specifying unit 5d calculates the ratio (h/w) between the lengths in the up and down direction and in the right and left direction of the eye E calculated by the first calculation unit 5c, and determines whether or not the ratio (h/w) is within a predetermined range (step S22).

Here, if it is determined that the ratio (h/w) is within the predetermined range (step S22; YES), the shape specifying unit 5d specifies that the eye E to be processed is in a shape of a human eye E having an oblong elliptical shape (see FIG. 4A) (step S23). Then, as a control condition for allowing blink movement of the eye E, the movement condition setting unit 5f sets only information showing movements of a plurality of control points corresponding to the upper eyelid (for example, deformation vector or the like) as a control condition (step S24). In that case, the deformation amount n of the lower eyelid is “0”, whereby movement is made by deformation of the upper eyelid with a deformation amount m.

On the other hand, if it is determined that the ratio (h/w) is not within the predetermined range (step S22; NO), the first calculation unit 5c calculates the length wt in the right and left direction of the upper portion and the length wb in the right and left direction of the lower portion of the eye E, respectively (step S25; see FIGS. 5B and 5C).

Then, the shape specifying unit 5d determines whether or not the length wt in the right and left direction of the upper portion and the length wb in the right and left direction of the lower portion of the eye E, calculated by the first calculation unit 5c, are almost equal (step S26).

At step S26, if it is determined that the length wt in the right and left direction of the upper portion and the length wb in the right and left direction of the lower portion of the eye E are not almost equal (step S26; NO), the shape specifying unit 5d specifies that the eye E to be processed is in a shape of a cartoon-like eye E (see FIG. 4B) (step S27).

Then, the movement condition setting unit 5f sets, as control conditions, correction contents of information showing the movements of a plurality of control points corresponding to the upper eyelid and the lower eyelid included in the reference movement data 3b such that the deformation amount of the eyelid corresponding to the shorter length (for example, deformation amount n of the lower eyelid) becomes relatively larger than the deformation amount of the eyelid corresponding to the longer length (for example, deformation amount m of the upper eyelid (step S28).

At this time, the movement condition setting unit 5f may set correction contents (deformation vector or the like) of the information showing the control points corresponding to the upper eyelid and the lower eyelid such that the corner of the eye is lowered in blink movement of the eye E (see FIG. 6B).

On the other hand, at step S26, if it is determined that the length wt in the right and left direction of the upper portion and the length wb in the right and left direction of the lower portion of the eye E are almost equal (step S26; YES), the shape specifying unit 5d specifies that the eye E to be processed is in the shape of an animal-like eye E (see FIG. 4C) which is an almost true circular shape (step S29).

Then, the movement condition setting unit 5f sets, as control conditions, correction contents of the information showing the movements of a plurality of control points corresponding to the upper eyelid and the lower eyelid included in the reference movement data 3b such that the deformation amount m of the upper eyelid and the deformation amount n of the lower eyelid become almost equal (step S30).

### <Mouth Control Condition Setting Processing>

Next, the mouth control condition setting processing will be described with reference to FIGS. 7 to 10.

FIG. 7 is a flowchart illustrating an exemplary operation according to the mouth control condition setting processing. Further, FIGS. 8A to 8C, FIGS. 9A to 9C, FIGS. 10A to 10C, and FIGS. 11A to 11C are diagrams for explaining the mouth control condition setting processing.

As illustrated in FIG. 7, the shape specifying unit 5d specifies the both right and left end portions of a boundary line L which is a joint between the upper lip and the lower lip of the mouth M detected by the face main part detection unit 5b, as positions of the right and left mouth corners Mr and Ml, and specifies an almost center portion in the right and left direction of the boundary line L as the mouth center portion Mc (step S41).

Then, the shape specifying unit 5d determines whether or not the right and left mouth corners Mr and Ml and the mouth center portion Mc are at almost equal up and down positions (step S42).

At step S42, if it is determined that the right and left mouth corners Mr and Ml and the mouth center portion Mc are not at almost equal up and down positions (step S42; NO), the shape specifying unit 5d determines whether or not the mouth center portion Mc is high relative to the right and left mouth corners Mr and Ml in the up and down positions (step S43).

Here, if it is determined that the mouth center portion Mc is high relative to the right and left mouth corners Mr and Ml in the up and down position (step S43; YES), the movement condition setting unit 5f sets, as control conditions, correction contents of information showing movements of a plurality of control points corresponding to the mouth corners Mr and Ml included in the reference movement data 3b such that the deformation amount in an upward direction of the right and left mouth corners Mr and Ml becomes relatively larger (step S44; see FIG. 10B).

On the other hand, at step S43, if it is determined that the mouth center portion Mc is not high relative to the right and left mouth corners Mr and Ml in the up and down positions (the right and left mouth corners Mr and Ml are high relative to the mouth center portion Mc in the up and down positions) (step S43; NO), the movement condition setting unit 5f sets, as control conditions, correction contents of the information showing the movements of the control points corresponding to the right and left mouth corners Mr and Ml included in the reference movement data 3b such that the deformation amount in a downward direction of the right and left mouth corners Mr and Ml becomes relatively larger (step S45; see FIG. 10C).

It should be noted that if it is determined at step S42 that the right and left mouth corners Mr and Ml and the mouth center portion Mc are at almost equal up and down positions (step S42; YES), the movement condition setting unit 5f does not correct information showing the movements of the control points corresponding to the upper lip, the lower lip, and the right and left mouth corners Mr and Ml included in the reference movement data 3b.

Then, the second calculation unit 5e calculates the length lm in the right and left direction of the mouth M, the length if in the right and left direction of the face at a position corresponding to the mouth M, and the length lj in the up and down direction from the mouth M to the tip of the chin, respectively (step S46; see FIG. 9A and elsewhere).

Then, the movement condition setting unit 5f determines whether the length lj in the up and down direction from the mouth M to the tip of the chin is relatively large with reference to the length lm in the right and left direction of the mouth M (step S47).

At step S47, if it is determined that the length lj in the up and down direction from the mouth M to the tip of the chin is relatively large (step S47; YES), the movement condition setting unit 5f sets, as control conditions, information showing the movements of the control points corresponding to the upper lip, the lower lip, and the right and left mouth corners Mr and Ml defined in the reference movement data 3b (step S48).

On the other hand, at step S47, if it is determined that the length lj in the up and down direction from the mouth M to the tip of the chin is not relatively large (step S47; NO), the movement condition setting unit 5f determines whether or not the right and left areas of the mouth M in the face contour are relatively large with respect to the length lm in the right and left direction of the mouth M (step S49).

At step S49, if it is determined that the right and left areas of the mouth M in the face contour are not relatively large (step S49; NO), the movement condition setting unit 5f sets, as control conditions, correction contents of the information showing the movements of the control points corresponding to the upper lip and the lower lip included in the reference movement data 3b such that the deformation amount in a downward direction of the lower lip becomes relatively smaller (step S50; see FIG. 11B).

On the other hand, if it is determined that the right and left areas of the mouth M in the face contour are relatively large (step S49; YES), the movement condition setting unit 5f sets, as control conditions, correction contents of the information showing the movements of the control points corresponding to the right and left mouth corners Mr and Ml included in the reference movement data 3b such that the deformation amount in the right and left direction of the right and left mouth corners Mr and Ml becomes relatively larger (step S51; see FIG. 11C).

As described above, according to the movement processing apparatus 100 of the present embodiment, the shape types of the main parts (for example, the eye E, the mouth M, and the like) forming the face detected from a face image are specified, and based on the specified shape types of the main parts, control conditions for moving the main part are set. As such, it is possible to allow appropriate movements corresponding to the shape types of the main parts of the face according to the control conditions in the face image. Thereby, as local degradation of the image quality and unnatural deformation can be prevented, movements of the main parts of the face can be made more naturally.

Further, as the shape type of the eye E is specified based on the ratio between the length h in the up and down direction and the length w in the right and left direction of the eye E as a main part of the face, it is possible to properly specify the shape of the human eye E which is an oblong elliptical shape. Further, as the shape type of the eye E is specified by comparing the length wt in the right and left direction of the upper portion and the length wb in the right and left direction of the lower portion of the eye E, it is possible to properly specify the shape of a cartoon-like eye E, or the shape of an animal-like eye E which is an almost true circular shape. Then, it is possible to allow blink movement of the eye E more naturally, according to the control conditions set based on the shape type of the eye E.

Further, by controlling deformation of at least one of the upper eyelid and the lower eyelid when allowing blink movement of the eye E according to the size of the length wt in the right and left direction of the upper portion and the length wb in the right and left direction of the lower portion of the eye E, it is possible to allow natural blink movement in which unnatural deformation is prevented even if the eye E to be processed is in the shape of a cartoon-like eye E or the shape of an animal-like eye E.

Further, as the shape type of the mouth M is specified based on the positional relation in the up and down direction of the right and left mouth corners Mr and Ml and the mouth center portion Mc of the mouth M as a main part of the face, it is possible to properly specify the shape of the mouth M in which the right and left mouth corners Mr and Ml and the mouth center portion Mc are almost equal in the up and down positions, the shape of the mouth M in which the mouth center portion Mc is high relative to the right and left mouth corners Mr and Ml in the up and down positions, the shape of the mouth M in which the right and left mouth corners Mr and Ml are high relative to the mouth center portion Mc in the up and down positions, or the like. Then, opening/closing movement of the mouth M can be performed more naturally according to the control conditions set based on the shape type of the mouth M.

Further, it is possible to set control conditions for allowing opening/closing movement of the mouth M based on the relative positional relation of the mouth M to a main part (for example, tip of the chin) other than the mouth M detected by the face main part detection unit 5b. Specifically, the relative positional relation of the mouth M to a main part other than the mouth M is specified based on the length lm in the right and left direction of the mouth M, the length if in the right and left direction of the face at a position corresponding to the mouth M, and the length lj in the up and down direction from the mouth M to the tip of the chin. As such, it is possible to set control conditions for allowing opening/closing movement of the mouth M while taking into account the size of the right and left areas of the mouth M in the face contour, the length lj in the up and down direction from the mouth M to the tip of the chin, and the like. As such, opening/closing movement of the mouth M can be made more naturally according to the set control conditions.

Further, by preparing the reference movement data 3b including information showing movements serving as the basis for expressing movements of respective main parts of a face, and setting, as control conditions, correction contents of information showing the movements of a plurality of control points for moving the main pats included in the reference movement data 3b, it is possible to move the main parts of the face more naturally, without preparing data for moving the main parts of the face according to the various shape types, respectively. That is to say, there is no need to prepare movement data including information of movements of the main parts by each type of source image such as a photograph or illustration or each type of face such as a human or an animal. As such, it is possible to reduce the work load in the case of preparing them and to prevent an increase in the capacity of a storing unit which stores such data.

It should be noted that the present invention is not limited to the embodiment described above, and various modifications and design changes can be made within the scope not deviating from the effect of the present invention.

Further, while the embodiment described above is formed of a single unit of movement processing apparatus 100, this is an example and the present invention is not limited thereto. For example, the present invention may be applied to a projection system (not illustrated) for projecting, on a screen, a video content in which a projection target object such as a human, a character, an animal, or the like explains a product or the like.

Further, in the embodiment described above, while movement data for moving the main parts is generated based on the control conditions set by the movement condition setting unit 5f, this is an example and the present invention is not limited thereto. The movement generation unit 5g is not necessarily provided. For example, it is also possible that the control conditions set by the movement condition setting unit 5f are output to an external device (not illustrated), and that movement data is generated in the external device.

Further, while the main parts are moved according to the control conditions set by the movement condition setting unit 5f, this is an example and the present invention is not limited thereto. The movement control unit 5h is not necessarily provided. For example, it is also possible that the control conditions set by the movement condition setting unit 5f are output to an external device (not illustrated), and that the main parts are moved according to the control conditions in the external device.

Further, the configuration of the movement processing apparatus 100, exemplarily described in the embodiment described above, is an example, and the present invention is not limited thereto. For example, the movement processing apparatus 100 may be configured to include a speaker (not illustrated) which outputs sounds, and output a predetermined sound from the speaker in a lip-sync manner when performing processing to move the mouth M in the face image. The data of the sound, output at this time, may be stored in association with the reference movement data 3b, for example.

In addition, the embodiment described above is configured such that the functions as an acquisition unit, a detection unit, a specifying unit, and a setting unit are realized by the image acquisition unit 5a, the face main part detection unit 5b, the shape specifying unit 5d, and the movement condition setting unit 5f which are driven under control of the central control unit 1 of the movement processing apparatus 100. However, the present invention is not limited thereto. A configuration in which they are realized by a predetermined program or the like executed by the CPU of the central control unit 1 is also acceptable.

This means that in a program memory storing programs, a program including an acquisition processing routine, a detection processing routine, a specifying processing routine, and a setting processing routine is stored. Then, by the acquisition processing routine, the CPU of the central control unit 1 may be caused to function as a unit that acquires a face image. Further, by the detection processing routine, the CPU of the central control unit 1 may be caused to function as a unit that detects main parts forming the face from the acquired face image. Further, by the specifying processing routine, the CPU of the central control unit 1 may be caused to function as a unit that specifies the shape types of the detected main parts. Further, by the setting processing routine, the CPU of the central control unit 1 may be caused to function as a unit that sets control conditions for moving the main parts, based on the specified shape types of the main parts.

Similarly, the first calculation unit, the second calculation unit, and the movement control unit, may also be configured to be realized by a predetermined program and the like executed by the CPU of the central control unit 1.

Further, as a computer-readable medium storing a program for executing the respective units of processing described above, it is also possible to apply a non-volatile memory such as a flash memory or a portable recording medium such as a CD-ROM, besides a ROM, a hard disk, or the like. Further, as a medium for providing data of a program over a predetermined communication network, a carrier wave can also be applied.

While some embodiments of the present invention have been described, the scope of the present invention is not limited to the embodiments described above, and includes the scope of the invention described in the claims and the equivalent scope thereof.

What is claimed is:

1. A movement processing apparatus comprising:
an acquisition unit configured to acquire a face image;
a detection unit configured to detect a main part forming a face from the face image; and
a control unit configured to:
specify a shape type of the main part; and
set a control condition for moving the main part based on the specified shape type of the main part.

2. The movement processing apparatus according to claim 1, wherein
the control unit further specifies a shape type of an eye as the main part, and further sets a control condition for allowing blink movement of the eye, based on the specified shape type of the eye.

3. The movement processing apparatus according to claim 2, wherein
the control unit calculates a first length in an up and down direction of the eye and a second length in a right and left direction of the eye, respectively, and specifies the shape type of the eye based on a ratio between the first length and the second length.

4. The movement processing apparatus according to claim 3, wherein
the control unit calculates a third length in a right and left direction of an upper portion of the eye and a 4th length in a right and left direction of a lower portion of the eye, respectively, and specifies the shape type of the eye by comparing the third length and the 4th length.

5. The movement processing apparatus according to claim 4, wherein
the control unit sets a control condition for controlling deformation of at least one of an upper eyelid and a lower eyelid when allowing blink movement of the eye, according to the third length and the 4th length.

6. The movement processing apparatus according to claim 1, wherein
the control unit specifies a shape type of a mouth as the main part, and sets a control condition for allowing opening and closing movement of the mouth based on the specified shape type of the mouth.

7. The movement processing apparatus according to claim 6, wherein
the control unit specifies the shape type of the mouth based on a positional relation in an up and down direction between a mouth corner and a mouth center portion.

8. The movement processing apparatus according to claim 6, wherein
the control unit sets a control condition for allowing opening and closing movement of the mouth, based on a relative positional relation of the mouth to the detected main part other than the mouth.

9. The movement processing apparatus according to claim 8, wherein
the control unit calculates a 5th length in a right and left direction of the mouth, a 6th length in a right and left direction of the face at a position corresponding to the mouth, and a 7th length in an up and down direction from the mouth to a tip of a chin, respectively,
specifies a relative positional relation of the mouth to the main part other than the mouth, based on the 5th length, the 6th length, and the 7th length, and
sets a control condition for allowing opening and closing movement of the mouth based on the specified positional relation.

10. The movement processing apparatus according to claim 1, wherein
the control unit moves the main part according to the set control condition in the face image acquired by the acquisition unit.

11. A movement processing method using a movement processing apparatus, the method comprising the steps of:
processing to acquire a face image;
processing to detect a main part forming a face from the acquired face image;
processing to specify a shape type of the detected main part; and
processing to set a control condition for moving the main part based on the specified shape type of the main part.

12. A non-transitory computer-readable medium storing a program for causing a computer to execute:
acquisition processing to acquire a face image;
detection processing to detect a main part forming a face from the face image acquired by the acquisition processing;
specifying processing to specify a shape type of the main part detected by the detection processing; and
setting processing to set a control condition for moving the main part based on the shape type of the main part specified by the specifying processing.
